(19) United States
(12) Patent Application Publication
(10) Pub. No.: US 2011/0192874 A1
(43) Pub. Date: Aug. 11, 2011

(54) Ladder rack for vehicle

(76) Inventors: Bradley J. McCurry, East Ridge, TN (US); Kenneth M. Gilreath, Knoxville, TN (US)

(21) Appl. No.: 13/023,530

(22) Filed: Feb. 8, 2011

Related U.S. Application Data
(60) Provisional application No. 61/302,708, filed on Feb. 9, 2010.

(51) Int. Cl. B60R 7/00

(52) U.S. Cl. 224/539

(57) ABSTRACT

Apparatus for carrying a ladder on a vehicle. The ladder rack has a clamping assembly and a horizontal member hingedly connected with a pivoting mechanism. The clamping assembly includes an upper member with a pair of jaws that clamp the ladder to the clamping assembly. The jaws are selectively positionable along the vertical member. In one configuration a rung lock is attached to the clamping assembly and engages a rung of the ladder. The pivoting mechanism includes an axle and a locking member. Disengagement of the locking member allows the clamping assembly to swing or rotate about the axle relative to the horizontal member. In one embodiment, the horizontal member has a removable toolbox support that secures a toolbox or other object to the ladder rack.

### CROSS-REFERENCE TO RELATED APPLICATIONS

This application claims the benefit of U.S. Provisional Application No. 61/302,708, filed Feb. 9, 2010.

### STATEMENT REGARDING FEDERALLY SPONSORED RESEARCH OR DEVELOPMENT

Not Applicable

### BACKGROUND OF THE INVENTION

1. Field of Invention

This invention pertains to an apparatus for supporting and carrying a ladder on a vehicle. More particularly, this invention pertains to a device that attaches to a vehicle and securely supports a ladder during transport.

2. Description of the Related Art

Ladders provide easy access above ground level. Typically, ladders are sufficiently lightweight that most persons can easily move and setup the ladder. Because of this ease, ladders are often transported to remote sites and locations where access above ground is needed. But the size of most portable ladders is such that they are not easily transported by many passenger vehicles.

Commonly, ladders are carried on the top or roof of many vehicles, such as vans and sports utility vehicles. The placement of the ladder on top of the vehicle is problematic because the height of the top or roof of the vehicle makes it difficult to place and remove the ladder considering the limited reach of most persons. In many cases a ladder is needed in order to place and remove a ladder on the top or roof of the vehicle.

In other cases ladders are carried on the side of vehicles, such as vans. The ladder is held with hooks or straps on the side of the vehicle and the ladder protrudes outward from the side of the vehicle, making the vehicle wider than it already is. For the case where the ladder is a folding ladder, even more width is added to the vehicle to accommodate the additional thickness of the folding ladder. An advantage to transporting ladders attached to the side of the vehicle is that, because the ladder is typically at shoulder height, the ladder is easy to place and remove.

### BRIEF SUMMARY OF THE INVENTION

According to one embodiment of the present invention, a ladder rack for a vehicle is provided. The ladder rack includes a vertical member and a horizontal member joined with a swing mechanism. The vertical member includes a clamping assembly that has an upper jaw and a lower jaw. The pair of jaws cooperate to clamp the ladder to the ladder rack. The jaws have perpendicular members that are opposed. With the ladder clamped to the ladder rack, the perpendicular members extend beyond portions of the ladder such that the ladder cannot be removed from the ladder rack. The pair of jaws are lockable to the vertical members to provide an antitheft feature. The pair of jaws are configured to secure the ladder when the ladder is mounted either vertically or sideways to the ladder rack. When the ladder is mounted sideways, one embodiment has a rung lock attached to the vertical member. The rung lock is a security feature that prevents the ladder from being slid sideways out of the ladder rack.

The horizontal member includes a first end configured to engage a hitch receiver on a vehicle. In another embodiment, the first end is configured to attach to the vehicle, such as with a bolted bracket. In one embodiment, the horizontal member includes a second end for supporting a toolbox. In one such embodiment, a T-shaped toolbox support extends from the second end of the horizontal member.

The swing mechanism includes a pivot, which is an axle. The swing mechanism also includes a locking mechanism that locks the vertical member relative to the horizontal member. Disengaging the locking mechanism allows the vertical member to move between a first and a second position. The first position is an upright position suitable for transporting the ladder. The second position is a lowered position suitable for accessing the rear of the vehicle.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 is a side view of one embodiment of the ladder rack in the carrying position;

FIG. 2 is a side view of the ladder rack in the lowered position;

FIG. 3 is a side view of one embodiment of a ladder rack;

FIG. 4 is a perspective view of one embodiment of a toolbox support;

FIG. 5 is a top view of one embodiment of a rung lock;

FIG. 6 is a perspective view of one embodiment of an upper jaw;

FIG. 7 is a perspective view of another embodiment of an upper jaw showing a partial view of one embodiment of a stanchion;

FIG. 8 is a top view of one embodiment of a lower jaw;

FIG. 9 is a rear view of the lower jaw; and

FIG. 10 is a partial side view of one embodiment of a tilting mechanism.

### DETAILED DESCRIPTION OF THE INVENTION

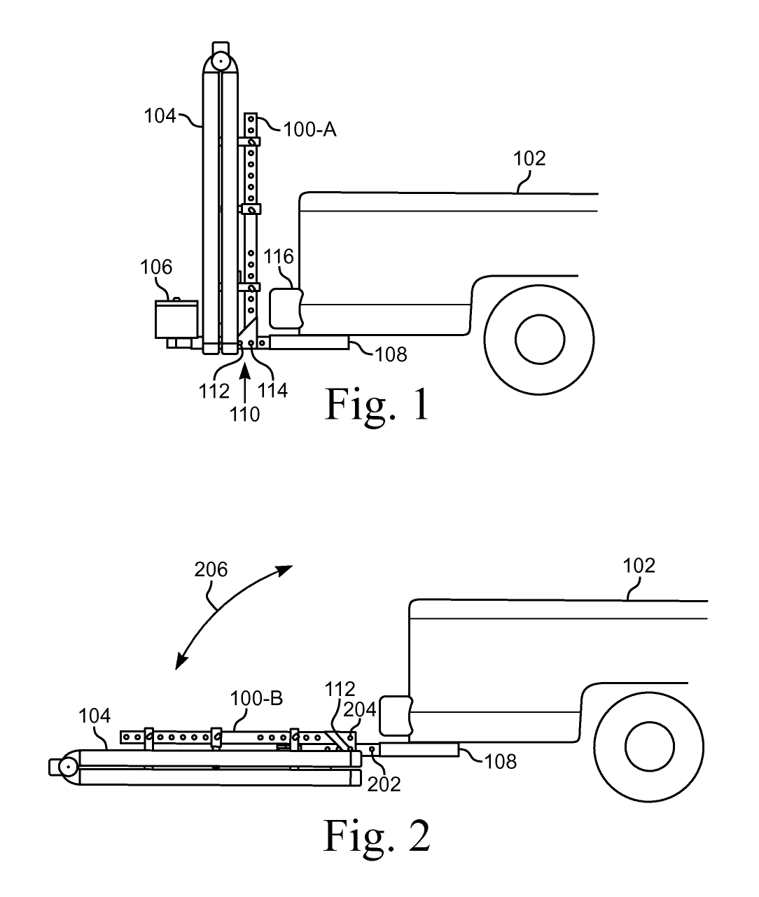

Apparatus for carrying a ladder 104 on the outside of a vehicle 102 is disclosed. Workers often need to transport ladders 104. One type of such ladder 104 is a folding ladder, such as an extension trestle ladder. Reference number 100 is used herein to refer to the ladder rack 100 generally without referring to a specific position, such as the upright position 100-A and the lowered position 100-B shown in FIGS. 1 and 2, respectively.

FIG. 1 illustrates a side view of one embodiment of the ladder rack 100-A in the carrying position. The ladder rack 100 is attached to a receiver 108 on a vehicle 102. In the illustrated embodiment, the vehicle 102 is a pickup truck. Those skilled in the art will recognize that any type of vehicle 102 can be used without departing from the spirit and scope of the present invention. In the illustrated embodiment, the vehicle 102 has a receiver 108 that receives the rack 100 and in other embodiments the rack 100 attaches directly to the vehicle, such as by bolts securing the rack 100 to the bumper 116 or the frame of the vehicle 102.

Mounted on the ladder rack 100-A is a ladder 104 and a tool box 106. The illustrated ladder 104 is a folding ladder with telescoping sections. In the carrying or upright position, the illustrated embodiment shows the ladder rack 100-A holding the ladder 104 in a vertically oriented position. In another embodiment, the ladder 104 is positioned sideways, that is, the feet of the ladder 104 are proximate one side of the vehicle 102 and the opposite end of the ladder 104 is proximate the opposite side of the vehicle 104. Rearward of the ladder 104 is a tool box 106 that is supported by the ladder rack 100-A.

FIG. 2 illustrates a side view of the ladder rack 100-B in the lowered position. The upright position of the ladder rack 100-A potentially blocks access to the rear of the vehicle 102. The vehicle 102 may have a tailgate, a liftgate, a door, or other access portal. By lowering the ladder rack 100-B, and the attached ladder 104, access to the rear of the vehicle 102 is possible. In one embodiment, the toolbox 106 must be removed to provide room for the ladder 104 in the lowered position 100-B. In one such embodiment, the toolbox support 320 must also be removed from the lower member 304 to provide sufficient clearance.

The ladder rack 100 swings between the upright position 100-A and the lowered position 100-B as indicated by the arrow 206. The ladder rack 100 includes a swing mechanism 110 that includes an axle 112. The upper portion of the ladder rack 100 pivots about the axle 112 when a pin 114 is removed from the openings 202, 204 in the rack 100-A. The openings 202, 204 are aligned when the ladder rack 100-A is in the upright position illustrated in FIG. 1. Upon removal of the pin 114, the upper portion of the rack 100 pivots downward to the lowered position 100-B illustrated in FIG. 2.

In the lowered position the ladder rack 100-B has sufficient clearance with the ground that the attached ladder 104 remains above the ground surface. The ladder rack 100-B is lowered sufficiently to allow the tailgate, the liftgate, the door, or other access portal of the vehicle 102 to be operated to gain access to the interior or the cargo area of the vehicle 102.

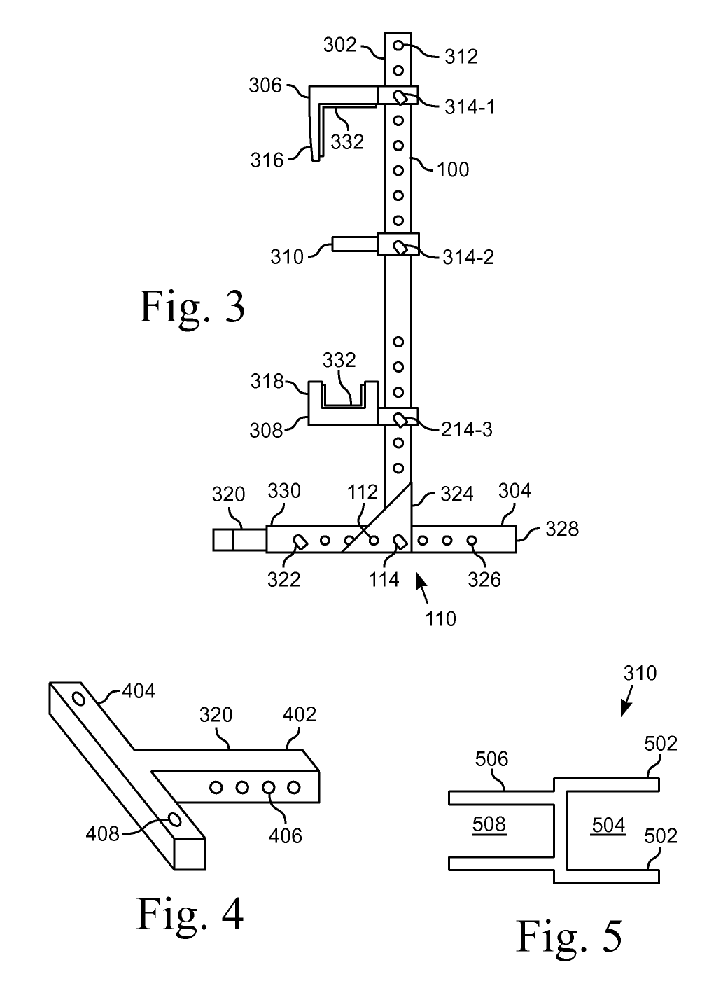

FIG. 3 illustrates a side view of one embodiment of a ladder rack 100. The rack 100 has an upper member 302 that is attached to a lower member 304. The upper member 302 is a tube, such as one with a rectangular or square cross-section, that has a series of through-openings 312 sized to receive a pin 314. Attached to the distal end of the upper member 302 is an upper jaw 306 that has retaining members 316 that are downward facing. The upper jaw 306 is attached to the upper member 302 by a pin 214-1 that engages an opening 608 in the jaw 306 and an opening 312 in the upper member 302. In one embodiment, the pin 314-1 locks when it is in position. That is, the pin 314-1 cannot be removed from the openings 312, 608 without a key, a combination, or other unlocking method. In this way the upper jaw 306 is fixed in position. For example, when the downward facing members 316 engage a rung of an upright ladder 104 or a siderail of a sideways ladder 104, the upper jaw 306 is locked in position.

Adjacent the proximal end of the upper member 302 is a lower jaw 308 that has retaining members 318 that are upward facing. The lower jaw 308 is attached to the upper member 302 by a pin 314-3 that engages an opening 808 in the lower jaw 308 and an opening 312 in the upper member 302. In one embodiment, the pin 314-3 locks when it is in position. That is, the pin 314-3 cannot be removed from the openings 312, 808 without a key, a combination, or other unlocking method. In this way the lower jaw 308 is fixed in position. For example, when the upward facing members 318 engage a rung of an upright ladder 104 or a siderail of a sideways ladder 104, the lower jaw 308 is locked in position. With both the upper jaw 306 and the lower jaw 308 locked in position and clamping rungs of the ladder 104, the ladder 104 cannot be removed from the ladder rack 100 without unlocking one or both of the jaws 306, 308.

When the ladder rack 100 is to be used to secure a ladder 104 in an upright position, the lower jaw 308 is adjusted to a height sufficient to engage a rung of the ladder 104 such that the rung is between the upward facing members 318 and the upper member 302 with the feet of the ladder 104 at a desired elevation above the ground. The upper jaw 306 is adjusted to a height sufficient to engage another rung of the ladder 104 such that the rung is between the downward facing members 316 and the upper member 302. The pins 314-1, 314-3 secure the jaws 306, 308 to the upper member 302 such that the downward and upward facing members 316, 318 prevent the ladder 104 from being pulled away from the upper member 302. With both pins 314-1, 314-3 locked in position, the ladder 104 cannot be removed from the ladder rack 100 without unlocking one or both of the pins 314-1, 314-3.

In the illustrated embodiment, the surfaces of the upper and lower jaws 306, 308 that contact the ladder 104 are lined with a resilient material 332, such as a closed cell foam or rubber-like material. In this way vibration of the ladder 104 against the ladder rack 100 is minimized. In one embodiment, the ladder 104 is clamped in position by the upper and lower jaws 306, 308. In another embodiment, the ladder 104 is also secured in position with ropes, cords, elastic bands, bungee cords, or other fastening devices to prevent the ladder 104 from moving relative to the ladder rack 104 when the vehicle is in motion.

Between the upper jaw 306 and the lower jaw 308 is a rung lock 310. The run lock 310 attaches to the upper member 302 with a pin 314-2. When the ladder 104 is held sideways by the ladder rack 100, such that the upper and lower jaws 306, 308 engage the outside of the siderails of the ladder 104, the rung lock 310 engages at least one rung of the ladder 104. With the rung lock 310 engaging at least one rung, the ladder 104 cannot be slid out of the ladder rack 100 sideways. In one embodiment the pin 314-2 locks the rung lock 310 to the upper member 302. In the embodiment in which the upper and lower jaws 306, 308 engage the inside of the siderails of the ladder 104, the rung lock 310 is not required to secure the ladder 104 because the jaws 306, 308 are constrained by a pair of rungs and the siderails.

The lower member 304 is a tube, such as one with a rectangular or square cross-section, that has a series of through-openings 324 sized to receive a pin 112, 322. The lower member 304 is connected to the upper member with a swing mechanism 110. The swing mechanism 110 allows the upper member 302 to swing about the axle 112, which is fixed in the lower member 304. In the illustrated embodiment, a pair of braces 324 are secured to the upper member 302, such as by bolting or welding. The braces 324 have openings that are coincident with the openings 326 in the lower member 304. The axle 112 is a cylindrical member that engages one opening 326 in the lower member 304 and an opening in the braces 324. In one embodiment, the axle 112 is a bolt or other fastener that remains in place and has bearing surfaces that allow the upper member 302 to swing relative to the lower member 304. In another embodiment, the axle 112 is a hitch-type pin. The swing mechanism 110 also includes a locking device that, in the illustrated embodiment, is pin 114 that removably engages openings in the braces 324 and an opening 324 in the lower member 304. With the pin 114 engaging the openings 324, the upper member 302 is locked in position relative to the lower member 304. With the pin 114 disengaging the openings 324, the upper member 302 is free to pivot about the axle 112 relative to the lower member 304.

One end 328 of the lower member 304 is sized to engage the receiver 108 mounted on the vehicle 102. The end 328 of the lower member 304 is secured in the receiver 108 with a hitch pin. The opposite end 330 of the lower member 304 receives a toolbox support 320. The toolbox support 320 is secured to the lower member 304 with a pin 322 that engages an opening 326 in the lower member and a coinciding opening 406 in the toolbox support 320. The pin 322, in one embodiment, is a locking pin that locks the toolbox support 320 to the lower member 304.

In another embodiment, the ladder rack 100 is configured to support two ladders 104, one on each side of the upper member 302. In such an embodiment the jaws 306, 308 each have a pair of retaining members 306, 308 that are on opposite sides of the upright member 302. In this way a ladder 104 is secured with one set of retaining members 306, 308 on one side of the upright member 302 and a second ladder 104 is secured with the other set of retaining members 306, 308 on the other side of the upright member 302. In this way each ladder 104 is independently supported and can be positioned on the rack 100 and removed independently of the other ladder 104.

FIG. 4 illustrates a perspective view of one embodiment of a toolbox support 320. The toolbox support 320 includes a member 402 configured to engage the lower member 304. The illustrated member 402 slides into the lower member 304 until the opening 406 is aligned with a desired opening 324 in the lower member 304. A pin 322 secures the toolbox support 320 to the lower member 304.

The toolbox support 320 also includes a cross-member 404 that provides lateral support for the toolbox 106. The bottom of the toolbox 106 rests on the cross-member 404 and one or both of the member 402 and the lower member 304. In one embodiment, the toolbox support 320 cross-member 404 includes openings 408 for fasteners that secure the toolbox 106 to the toolbox support 320. In another embodiment, the toolbox 106 is secured to the toolbox support 320 with ropes, cords, elastic bands, bungee cords, or other fastening devices. In yet another embodiment, the toolbox support 302 has a cross-member 404 that is configured to mate with the toolbox 106 and cradle or receive the toolbox 106, such as with a basket.

FIG. 5 illustrates a top view of one embodiment of a rung lock 310. The illustrated embodiment has two sidewalls 502 that define an opening 504 therebetween. The opening 504 is dimensioned to engage the upper member 302. The sidewalls 502 each have an opening through which the pin 314-2 passes to attach the rung lock 310 to the upper member 302.

The rung lock 310 also includes a pair of rung jaws 506 that define an opening 508 therebetween. The opening 508 is dimensioned to receive a rung of the ladder 104 between the jaws 506. When the ladder 104 is positioned sideways on the ladder rack 100, the rungs are oriented vertically and at least one rung is positioned between the jaws 506. In this way the ladder 104 cannot be moved sideways and slid out from the upper and lower jaws 306, 308 because the ladder 104 is restrained by the rung jaws 506.

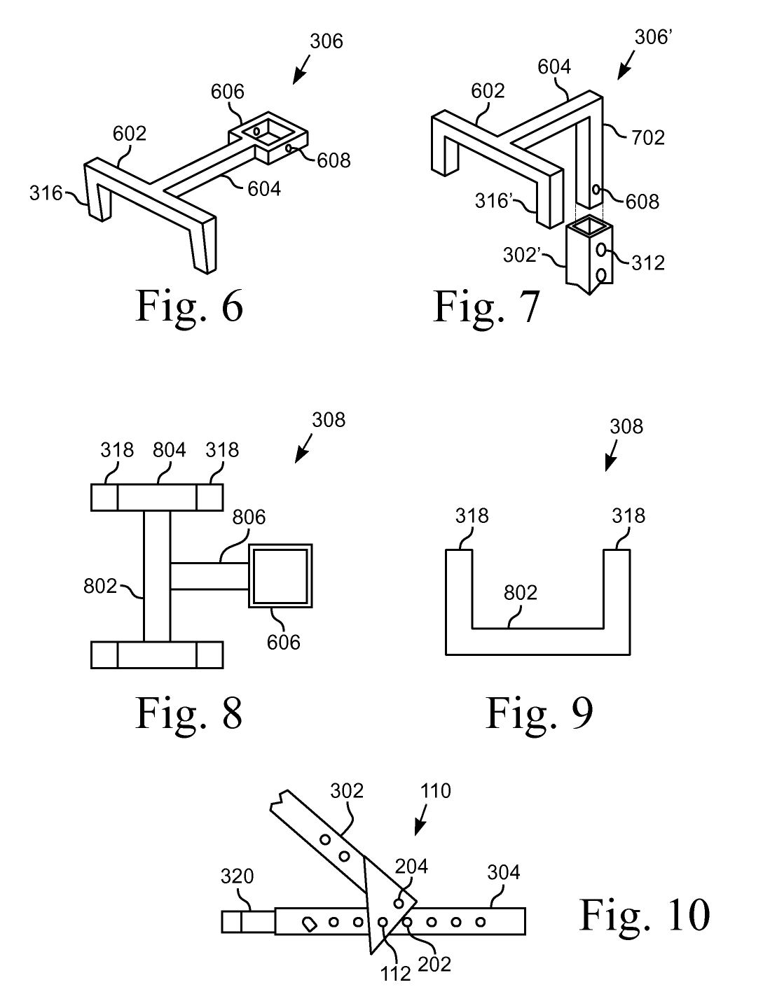

FIG. 6 illustrates a perspective view of one embodiment of an upper jaw 306. The illustrated embodiment of the upper jaw 306 has a pair of downward facing members 316 that are connected with a cross-member 602. An extension 604 connects the cross-member 602 to the connector 606. The connector 606 includes a pair of opposing holes 608. The connector 606 fits around and slides along the upper member 304. The pin 314-1 engages the holes 608 in the connector 606 and the opening 312 in the upper member 302 when the upper jaw 306 is located at the desired position.

FIG. 7 illustrates a perspective view of another embodiment of an upper jaw 306′ showing a partial view of one embodiment of a stanchion 302′. In the illustrated embodiment, the downward facing members 316′ are tubular members contrasted to the tapered members 316 illustrated in the embodiment of FIG. 6. The extension 604 connects to a bar 702 that fits into the upper member 304′. The bar 702 includes at least one through-hole 608 that receives the pin 314-1 when the hole 608 is aligned with a desired opening 312 in the upper member 302′.

In the embodiment illustrated in FIG. 7, the upper member 302′ is shorter than the upper member 302 for the embodiment illustrated in FIG. 6. The bar 702 allows the upper jaw 306′ to extend beyond the end of the upper member 302′. The series of openings 312 in the upper member 302′ allow the upper jaw 306′ to be selectively positioned.

FIG. 8 illustrates a top view of one embodiment of a lower jaw 308. FIG. 9 illustrates a rear view of the lower jaw 308. The illustrated embodiment of the lower jaw 308 includes a pair of cradles that each have a pair of upward facing members 318 joined with a cross-member 804. The cradles 318, 804 are joined with another cross-member 802 to form a rigid cradle assembly that supports the weight of the ladder 104. The cross-member 802 is connected to the connector 606 with an extension 806.

The upper and lower jaws 306, 308 are reversible. As described above, the lower jaw 308 supports the weight of the ladder 104 and the upper jaw 306 clamps the ladder 104 between the jaws 306, 308, thereby preventing the ladder 104 from being removed from the rack 100. In another configuration, the upper and lower jaws 306, 308 are swapped. The lower jaw 308 is positioned above the upper jaw 306. In such a configuration the upward facing members 318 and the downward facing members 316 are facing away from each other. By moving the jaws 306, 308 apart the ladder 104 is gripped by tension instead of compression.

In yet another configuration, the upper jaw 306 is above the lower jaw 308 and the upper jaw 306 is reversed such that the downward facing members 316 are facing upwards. The lower jaw 308 is likewise reversed such that the upward facing members 318 are now downward facing. As with the above configuration, moving the jaws 306, 308 apart grips the ladder 104 with tension instead of compression. In such an embodiment the upper jaw 306 supports the weight of the ladder 104, unlike the illustrated embodiment where the lower jaw 308 supports the ladder 104.

FIG. 10 illustrates a partial side view of one embodiment of a tilting mechanism 110. The upper member 302 is illustrated in a position midway between the upright and the lowered position. The axle 112 is the pivot for the upper member 304. In one embodiment, the lower position of the ladder rack 100-B is when one surface of the upper member 302 rests on the upper surface of the lower member 304. In such an embodiment the longitudinal axis of the upper member 302 is parallel with the longitudinal axis of the lower member 304. In such an embodiment, the upper member 302 rotates approximately 90 degrees from the upright position to the lowered position. In various embodiments the upper member 302 rotates approximately 30 degrees to 90 degrees.

The ladder rack 100 includes various functions. The function of swinging the upper member 302 relative to the lower member 304 is implemented, in one embodiment, by the axle 112. A pin 114 fixes the upper member 302 in an upright position relative to the lower member 304.

The function of securing the ladder 104 to the ladder rack 100 is implemented, in one embodiment, by the pair of jaws 306, 308 in which at least one of the pair of jaws 306, 308 moves relative the other, thereby clamping the ladder 104 in position. In one such embodiment, the restraining members 316, 318 face each other and the jaws 306, 308 move towards each other to clamp the ladder 104. In another embodiment, the restraining members 316, 318 point in opposite directions and the jaws 306, 308 move apart to grasp the ladder 104 and secure it in position. With the ladder 104 positioned vertically, the restraining members 316, 318 engage the rungs. With the ladder 104 positioned horizontally, the restraining members 316, 318 engage the side rails of the ladder 104.

The function of locking the ladder 104 when stored horizontally is implemented, in one embodiment, by the rung lock 310 that engages at least one rung of the ladder 104. In another embodiment, the function of locking the ladder 104 is implemented by the jaws 306, 308 clamping the ladder 104 such that the ladder 104 has members that interfere with sliding or otherwise removing the ladder 104 from between the jaws 306, 308.

The function of positioning the jaws 306, 308 along the upright member 302 is implemented, in one embodiment, by the connector 606 that engages the member 302. The connector 606 includes holes 608 that are in register with holes 312 in the upright member 302 at selected positions. A pin 314-1 engages the holes 608, 312 to lock the jaw 306, 308 in a selected position on the upright member 302.

The function of supporting an object, such as a tool box, is implemented, in one embodiment, by the toolbox support 320. In one such embodiment the support 320 has a T-shape that mates with the lower member 302. The crossbar 404 of the support 320 provides side-to-side support of the object. In one embodiment, the object is strapped to the support 320.

From the foregoing description, it will be recognized by those skilled in the art that a ladder rack 100 has been provided. The ladder rack 100 allows for transporting a ladder 104 and a toolbox 106 on the outside of a vehicle 102. The ladder rack 100 has two configurations, one in which the ladder rack 100-A is upright for transporting the ladder 104, and another in which the ladder rack 100-B is in a lowered position for accessing the rear of the vehicle 102. The ladder rack 100 has provisions for locking the ladder 104 to the ladder rack 100 by use of locking pins 214. The downward facing members 316 and the upward facing members 318 extend past portions of the ladder 104 such that the ladder 104 is locked to the ladder rack 100.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. An apparatus for securing a ladder to a vehicle, said apparatus comprising:
a first member having a proximal end and a distal end, said first member being elongated;
a first jaw attached to said first member, said first jaw extending from said first member, said first jaw having a plurality of first restraining members extending from a first extension member;
a second jaw attached to said first member, said second jaw extending from said first member, said second jaw having a plurality of second restraining members extending from a second extension member, said plurality of first restraining members configured in an opposed relationship to said plurality of second restraining members, in a first configuration said first jaw and said second jaw are movable relative to each other, in a second configuration said first jaw and said second jaw are fixed in position;
a second member having a first end and a second end, said first end of said second member configured to attach to a vehicle; and
a rotational mechanism connecting said proximal end of said first member to said second member, said rotational mechanism having an axis defining a center of rotation of said first member relative to said second member, said first member movable between a first position and a second position relative to said second member, said rotational mechanism having a locking mechanism fixing said first member in said first position, said first member movable to said second position when said locking mechanism is disengaged.

2. The apparatus of claim 1 wherein said first end of said second member is configured to mate with a receiver on said vehicle.

3. The apparatus of claim 1 wherein said first member rotates at least 30 degrees relative to said second member.

4. The apparatus of claim 1 wherein said first member rotates approximately 90 degrees relative to said second member.

5. The apparatus of claim 1 further including a toolbox support extending from said second end of said second member, said toolbox support configured to secure a toolbox to said apparatus.

6. The apparatus of claim 1 further including a box support extending from said second end of said second member, said box support having a proximal end configured to attach to said second end of said second member, said box support having a platform opposite said proximal end.

7. The apparatus of claim 1 further including a third member with a proximal end that slideably engages said first member between said first and second jaws, said third member having a distal end configured to engage a portion of the ladder to prevent the ladder from being removed from said apparatus when said first and second jaws are engaging said ladder.

8. The apparatus of claim 1 wherein said rotational mechanism includes a pair of plates, one of said first and second members fixed to said pair of plates, an other one of said first and second members connected to said pair of plates with a pivot that allows rotational movement between said first member and said second member, and said other one of said first and second members being releasably secured to said pair of plates such that rotational movement is inhibited when secured.

9. An apparatus for securing a ladder to a vehicle, said apparatus comprising:
a first member having a proximal end and a distal end, said first member being elongated with a longitudinal length;
a second member having a first end and a second end, said first end of said second member configured to attach to a vehicle, said proximal end of said first member connected to said second member with said first member in a first position that is substantially perpendicular to said second member;
a pair of jaws extending from said first member, each one of said pair of jaws having at least one restraining member extending in an opposing direction relative to an other one of said pair of jaws, at least one of said pair of jaws being movable along said longitudinal length of said first member whereby said pair of jaws cooperate to clamp a ladder therebetween.

10. The apparatus of claim 9 wherein said first end of said second member is configured to mate with a receiver on said vehicle.

11. The apparatus of claim 9 wherein said first member is connected to said second member with a tilting mechanism, said tilting mechanism having an axis defining a center of rotation of said first member relative to said second member, said first member movable between said first position and a second position relative to said second member, said tilting mechanism having a locking mechanism fixing said first member in said first position, said first member movable to said second position when said locking mechanism is disengaged.

12. The apparatus of claim 11 wherein said tilting mechanism includes a pair of plates, one of said first and second members fixed to said pair of plates, an other one of said first and second members connected to said pair of plates with a pivot that allows rotational movement between said first member and said second member, and said other one of said first and second members being releasably secured to said pair of plates such that rotational movement is inhibited when secured.

13. The apparatus of claim 9 further including a support member extending from said second end of said second member, said support member configured to secure an object to said apparatus.

14. The apparatus of claim 9 further including a support member extending from said second end of said second member, said support member having a proximal end configured to attach to said second end of said second member, said support member having a platform opposite said proximal end.

15. The apparatus of claim 9 further including a third member with a proximal end that slideably engages said first member between said pair of jaws, said third member having a distal end configured to engage a portion of the ladder to prevent the ladder from being removed from said apparatus when said pair of jaws are engaging said ladder.

16. An apparatus for securing a ladder to a vehicle, said apparatus comprising:
a clamping assembly configured to secure the ladder, said clamping assembly including a pair of jaws cooperating with a first member, at least one of said pair of jaws movable on said first member wherein a spacing between said pair of jaws is adjustable, and
a second member attached to said clamping assembly with a tilting mechanism, said second member having a first end configured to attach to the vehicle, said clamping assembly movable between a first position and a second position, in said first position said first member is substantially vertical when said second member is attached to the vehicle, said first member releasably fixed in said first position, in said second position said first member forms an obtuse angle relative to horizontal when said second member is attached to the vehicle.

17. The apparatus of claim 16 further including a support member extending from a second end of said second member, said support member having a proximal end configured to attach to said second end of said second member, and said support member having a platform.

18. The apparatus of claim 16 wherein each one of said pair of jaws include a contact member and a retaining member, each said contact member configured to engage a portion of the ladder, each said retaining member configured to restrain the ladder from disengaging said contact member when the ladder is moved away from said first member.

19. The apparatus of claim 16 wherein said tilting mechanism includes at least one plate fixed to one of said first and second members, said plate engaging an axle that engages an other one of said first and second members.

20. The apparatus of claim 19 wherein said tilting mechanism includes a locking mechanism that locks said tilting mechanism when said clamping assembly is in said first position.
